(19) United States
(12) Patent Application Publication
(10) Pub. No.: US 2017/0169742 A1
(43) Pub. Date: Jun. 15, 2017

(54) DISPLAY PANEL AND LARGE-SIZED DISPLAY PANEL

(71) Applicant: TOPPAN PRINTING CO., LTD., Taito-ku (JP)

(72) Inventors: Mamoru ISHIZAKI, Taito-ku (JP); Isao Ebisawa, Taito-ku (JP)

(73) Assignee: TOPPAN PRINTING CO., LTD., Taito-ku (JP)

(21) Appl. No.: 15/441,498

(22) Filed: Feb. 24, 2017

Related U.S. Application Data
(63) Continuation of application No. PCT/JP2015/004139, filed on Aug. 19, 2015.

(30) Foreign Application Priority Data
Aug. 27, 2014 (JP) 2014-172876

(51) Int. Cl. G09F 9/35; G09F 3/20; G09G 3/34; A47F 5/00; G09G 3/36

(52) U.S. Cl. CPC G09F 9/35; A47F 5/0018; G09G 3/3648; G09G 3/344; G09F 3/204; G09F 3/208; G09G 2300/026; G09G 2380/04; G09G 2380/02

(57) ABSTRACT

A display panel for a shelf board including a display part which displays the information and is to be placed on a front surface of a shelf board, a driving part which drives the display part and is to be placed on an underside of the shelf board along the shelf board, and a wiring part connecting the display part and the driving part. The wiring part extends from an outer periphery of the display part and is bent from a lower edge portion or an upper edge portion of the front surface toward the underside of the shelf board.

### CROSS-REFERENCE TO RELATED APPLICATIONS

The present application is a continuation of International Application No. PCT/JP2015/004139, filed Aug. 19, 2015, which is based upon and claims the benefits of priority to Japanese Application No. 2014-172876, filed Aug. 27, 2014. The entire contents of these applications are incorporated herein by reference.

### BACKGROUND OF THE INVENTION

Field of the Invention

The present invention relates to a display panel used for an electronic shelf label or the like. In addition, the present invention relates to a large-sized display panel that can perform large-sized display by connecting a plurality of display panels.

Discussion of the Background

Conventionally, display panels using a liquid crystal display (LCD) or electronic paper are supplied and are used as electronic shelf labels. FIG. 14 is a diagram showing an example of a conventional display panel for an electronic shelf label (refer to JP-A-2001-178599). As shown in the figure, a conventional electronic shelf label 20 is thick and high because the electronic shelf label 20 includes a driving part. Thus, there is a problem that the shelf label is more conspicuous than the commodities, whereby the important commodities are inconspicuous.

In addition, as shown in FIG. 15(a), the electronic shelf label 20, which is formed so as to be fixed by a clip part 20C, is easily detached. Thus, there has been a case where the electronic shelf label 20 is dropped when, for example, a commodity 21 is picked up, whereby the electronic shelf label 20 is damaged.

And when a variety of commodities 21 are arranged in a finely partitioned shelf, as shown in FIG. 15(b), the electronic shelf labels 20 are installed, the number of which is the same as the number of types of commodities. Thus, the shelf label 20 becomes further conspicuous, whereby the commodities 21 become inconspicuous.

### SUMMARY OF THE INVENTION

According to an aspect of the present invention, a display panel for a shelf board includes a display part which displays the information and is to be placed on a front surface of a shelf board, a driving part which drives the display part and is to be placed on an underside of the shelf board along the shelf board, and a wiring part connecting the display part and the driving part. The wiring part extends from an outer periphery of the display part and is bent from a lower edge portion or an upper edge portion of the front surface toward the underside of the shelf board.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1(a), 1(b) and 1(c) are a cross-sectional view, a front view, and a perspective view of a display panel according to an embodiment of the present invention;

FIGS. 2(a), 2(b) and 2(c) are a cross-sectional view, a front view, and a perspective view of a display panel according to an embodiment of the present invention;

FIGS. 3(a), 3(b) and 3(c) are a cross-sectional view, a front view, and a perspective view of a display panel according to an embodiment of the present invention;

FIGS. 4(a), 4(b) and 4(c) are a cross-sectional view, a front view, and a perspective view of a display panel according to an embodiment of the present invention; FIGS. 5(a), 5(b) and 5(c) are a cross-sectional view, a front view, and a perspective view of a display panel according to an embodiment of the present invention;

FIGS. 6(a), 6(b) and 6(c) are a cross-sectional view, a front view, and a perspective view of a display panel according to an embodiment of the present invention;

FIGS. 7(a), 7(b) and 7(c) are a cross-sectional view, a front view, and a perspective view of a display panel according to an embodiment of the present invention;

FIGS. 8(a) and 8(b) are a perspective view and a top view of a display panel for configuring a large-sized display panel according to an embodiment of the present invention;

FIGS. 9(a) and 9(b) are a perspective view and a top view of a display panel for configuring a large-sized display panel according to an embodiment of the present invention;

FIGS. 10(a), 10(b) and 10(c) are perspective views showing a procedure for configuring a large-sized display panel according to an embodiment of the present invention;

FIGS. 11(a) and 11(b) are perspective views showing examples of a large-sized display panel according to an embodiment of the present invention;

FIG. 12 is a perspective view showing example of a large-sized display panel according to an embodiment of the present invention;

FIG. 13 is a perspective view showing an example of a large-sized display panel according to an embodiment of the present invention;

FIG. 14 is a perspective view showing an example of a conventional display panel;

FIGS. 15(a) and 15(b) are perspective views showing an example of a conventional display panel.

### DESCRIPTION OF THE EMBODIMENTS

The embodiments will now be described with reference to the accompanying drawings, wherein like reference numerals designate corresponding or identical elements throughout the various drawings.

An embodiment of the present invention is a display panel that is installed to a shelf board to display information. The display panel includes a rectangular display part that is disposed on the front surface of the shelf board and displays information, a driving part that is disposed at the underside of the shelf board along the shelf board and drives the display part, and a wiring part that extends from the outer periphery of the display part and is bent from a lower edge or an upper edge of the front surface of the shelf board toward the underside, to connect the display part and the driving part.

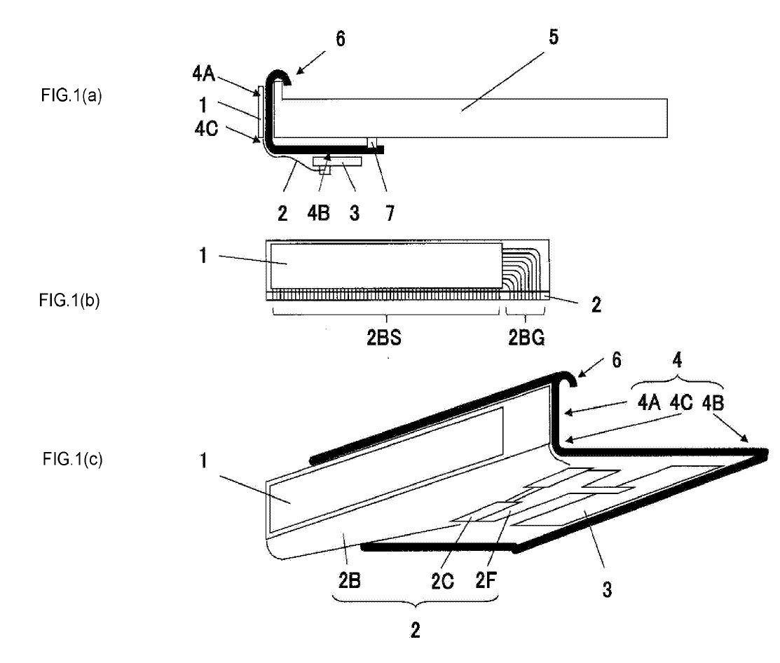

FIGS. 1(a)-1(c) are views showing the configuration of a display panel according to the embodiment. FIG. 1(a) is a cross-sectional view, FIG. 1(b) is a front view, and FIG. 1(c) is a perspective view. The display panel includes a display part 1, a wiring part 2, and a driving part 3. As shown in FIG. 1(a), the display panel is attached to a shelf board 5. The display part 1 is attached to the front surface side of the shelf board 5. The wiring part 2 extending from the display part 1 is bent in the vicinity of a lower edge of the display part 1 and at approximately 90°, and is disposed at the lower surface side of the shelf board 5 and is along the shelf board 5. Here, the approximately 90° is an angle between a plane including an upper edge and the lower edge of the display part 1, and the wiring part 2. Note that the angle is not necessarily 90° but may be larger or smaller than 90°. For example, the angle may be in a range of 85° to 95°. In addition, the wiring part 2 includes a source wiring extending from the lower edge of the display part 1 and a gate wiring extending from a right edge of the display part and curved downward. The wiring part 2 may include not only a simple wiring (2B) but also a driver IC (2C) and a flexible printed board (2F). The driving part 3 has at least a control circuit for performing display driving. The driving part 3 may further have an internal memory and an interface with an external database.

To dispose the display part 1, the wiring part 2, and the driving part 3 as described above, a rigid base 4 is used. The base 4 is a member for keeping the positions of the display part 1, the wiring part 2, and the driving part 3. The base 4 includes a front part 4A to which the display part 1 is fixed, a planar part 4B to which the wiring part 2 and the driving part 3 are fixed, and a bent part 4C that has a predetermined curvature radius and joins the front part and the planar part to each other. The fixing portion of the wiring part 2 and the driving part 3 may be on a lower surface or an upper surface of the planar part 4B. The material of the base 4 may be metal, plastic, or a combination thereof. The display part 1, the wiring part 2, and the driving part 3 are fixed to the base 4 by an adhesive, single-sided adhesive tape, double-sided adhesive tape, screws, or the like, which are not shown in FIGS. 1(a)-1(c). The bent part 4C of the base 4 has a certain curvature radius or larger. Even when the display part 1 and the wiring part 2 are fixed along the base 4, a certain curvature radius or larger of the wiring 2B is kept, whereby wiring resistance can be prevented from increasing due to bending.

The base 4 has a hook part 6 on the back side of the upper edge of the display part 1. Hanging the hook part 6 on the upper edge of the front surface of the shelf board 5 can prevent the display panel from being displaced downward or frontward. In addition, the base 4 has a magnet 7 in the vicinity of the wiring part 2 or the driving part 3. When the shelf board 5 is made of magnetic metal, the magnet 7 sticks to the shelf board 5, whereby the wiring part 2 and driving part 3 are prevented from dangling.

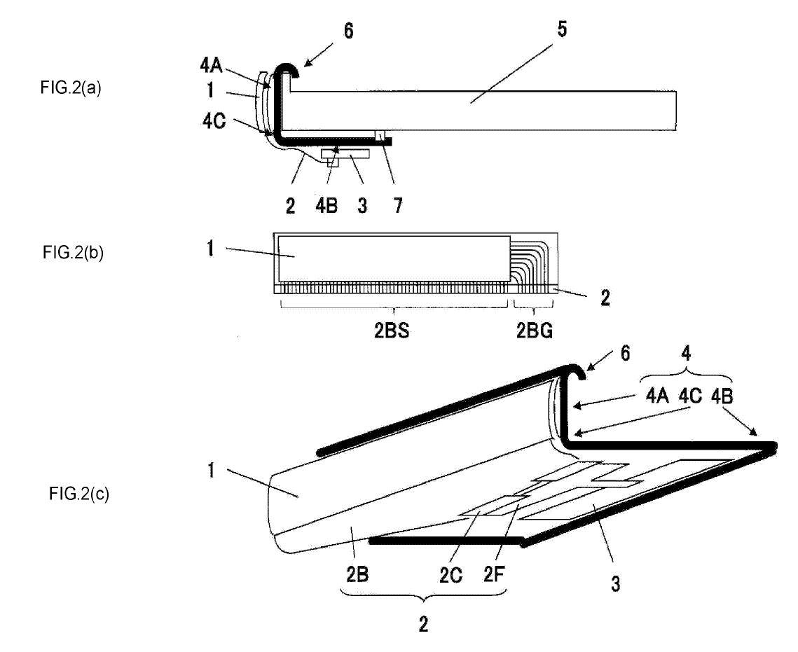

FIGS. 2(a)-2(c) are views showing the configuration of a display panel according to another embodiment of the present invention. FIG. 2(a) is a cross-sectional view, FIG. 2(b) is a front view, and FIG. 2(c) is a perspective view. The display panel includes the display part 1, the wiring part 2, and the driving part 3. As shown in FIG. 2(a), the display panel is attached to the shelf board 5. The display part 1 is attached to the front surface side of the shelf board 5. The wiring part 2 extending from the display part 1 is bent in the vicinity of the lower edge of the display part 1 at approximately 90°, and is disposed at the lower surface side of the shelf board 5 along the shelf board 5. Here, the approximately 90° is an angle between a plane including the upper edge and the lower edge of the display part 1, and a plane of most of the wiring part 2. Note that the angle is not necessarily 90° but may be larger or smaller than 90°. For example, the angle may be in a range of 85° to 95°. In addition, the wiring part 2 includes the source wiring extending from the lower edge of the display part 1 and the gate wiring extending from the right edge of the display part and curved downward. In FIG. 2(a), the display part 1 has a curved surface shape curved with respect to the vertical direction. According to the curved surface shape, even a slightly curved surface having a large curvature radius is felt to be soft in appearance. Thereby, the favorability rating of the commodity increases, which provides an effect of increasing purchasing willingness of consumers. In addition, the curved surface shape provides an advantage that the upper part of the display part 1 easily receives light from the ceiling, which makes indication of the display part 1 bright. The wiring part 2 may include not only a simple wiring (2B) but also a driver IC (2C) and a flexible printed board (2F). The driving part 3 has at least a control circuit for performing display driving. The driving part 3 may further have an internal memory and an interface with an external database.

To dispose the display part 1, the wiring part 2, and the driving part 3 as described above, a rigid base 4 (having high rigidity) is used. The base 4 is a member for keeping the positions of the display part 1, the wiring part 2, and the driving part 3. The base 4 includes the front part 4A to which the display part 1 is fixed, the planar part 4B to which the wiring part 2 and the driving part 3 are fixed, and the bent part 4C that has a predetermined curvature radius and joins the front part and the planar part to each other. The fixing portion of the wiring part 2 and the driving part 3 may be on the lower surface or the upper surface of the planar part 4B. The material of the base 4 may be metal, plastic, or a combination thereof. The display part 1, the wiring part 2, and the driving part 3 are fixed to the base 4 by an adhesive, single-sided adhesive tape, double-sided adhesive tape, screws, or the like, which are not shown in FIGS. 2(a)-2(c). The bent part 4C of the base 4 has a certain curvature radius or larger. Even when the flexible wiring part 2 is fixed along the base 4, a certain curvature radius or larger of the wiring part 2 is kept, whereby wiring resistance can be prevented from increasing due to bending. In FIG. 2(a), the front portion of the base 4 has a shape curved with respect to the vertical direction. Thus, the display part 1 is curved by placing the flexible display part 1 along the base 4.

The base 4 has the hook part 6 on the back side of the upper edge of the display part 1. Hanging the hook part 6 on the upper edge of the front surface of the shelf board 5 can prevent the display panel from being displaced downward or frontward. In addition, the base 4 has a magnet 7 provided in the vicinity of the wiring part 2 or the driving part 3. When the shelf board 5 is made of magnetic metal, the magnet 7 sticks to the shelf board 5, whereby the wiring part 2 and driving part 3 are prevented from dangling.

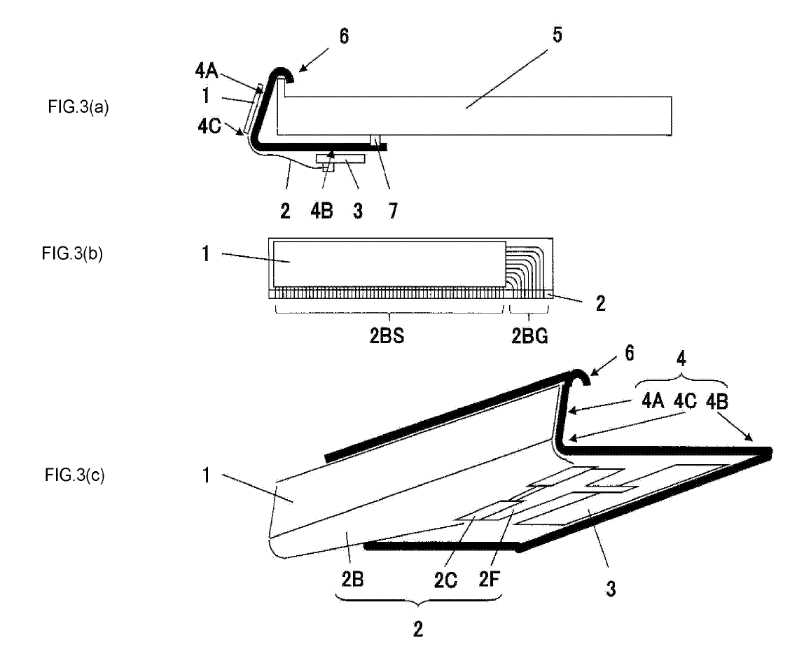

FIGS. 3(a)-3(c) are views showing the configuration of a display panel according to another embodiment of the present invention. FIG. 3(a) is a cross-sectional view, FIG. 3(b) is a front view, and FIG. 3(c) is a perspective view. The display panel includes the display part 1, the wiring part 2, and the driving part 3. As shown in FIG. 3(a), the display panel is attached to the shelf board 5. The display part 1 is attached to the front surface side of the shelf board 5, and inclines upward in a range of 5° to 30°. Thereby, the display part 1 can be seen from above the shelf board 5 with high visibility. Here, the range of 5° to 30° is a range of the angle between a plane including the upper edge and the lower edge of the display part 1, and the front surface of the shelf board 5. In addition, the wiring part 2 extending from the display part 1 is bent in the vicinity of the lower edge of the display part 1 in a range of 95° to 120°, and is disposed at the lower surface side of the shelf board 5 along the shelf board 5. Here, the range of 95° to 120° is a range of the angle between a plane including the upper edge and the lower edge of the display part 1, and a plane of most of the wiring part 2. In addition, the wiring part 2 includes the source wiring extending from the lower edge of the display part 1 and the gate wiring extending from the right edge of the display part and curved downward. The wiring part 2 may include not only the simple wiring (2B) but also a driver IC (2C) and a flexible printed board (2F). The driving part 3 has at least a control circuit for performing display driving. The driving part 3 may further have an internal memory and an interface with an external database.

To dispose the display part 1, the wiring part 2, and the driving part 3 as described above, a rigid base 4 is used. The base 4 is a member for keeping the positions of the display part 1, the wiring part 2, and the driving part 3. The base 4 includes a front part 4A to which the display part 1 is fixed, a planar part 4B to which the wiring part 2 and the driving part 3 are fixed, and a bent part 4C that has a predetermined curvature radius and joins the front part and the planar part to each other. The fixing portion of the wiring part 2 and the driving part 3 may be on a lower surface or an upper surface of the planar part 4B. The material of the base 4 may be metal, plastic, or a combination thereof. The display part 1, the wiring part 2, and the driving part 3 are fixed to the base 4 by an adhesive, single-sided adhesive tape, double-sided adhesive tape, screws, or the like, which are not shown in the FIGS. 3(a)-3(c). The bent part 4C of the base 4 has a certain curvature radius or larger. Even when the display part 1 and the wiring part 2 are fixed along the base 4, a certain curvature radius or larger of the wiring part 2 is kept, whereby wiring resistance can be prevented from increasing due to bending.

The base 4 has the hook part 6 on the back side of the upper edge of the display part 1. Hanging the hook part 6 on the upper edge of the front surface of the shelf board 5 can prevent the display panel from being displaced downward or frontward. In addition, the base 4 has a magnet 7 provided on the planar part 4B in the vicinity of the wiring part 2 or the driving part 3. When the shelf board 5 is made of magnetic metal, the magnet 7 sticks to the shelf board 5, whereby the wiring part 2 and driving part 3 are prevented from dangling.

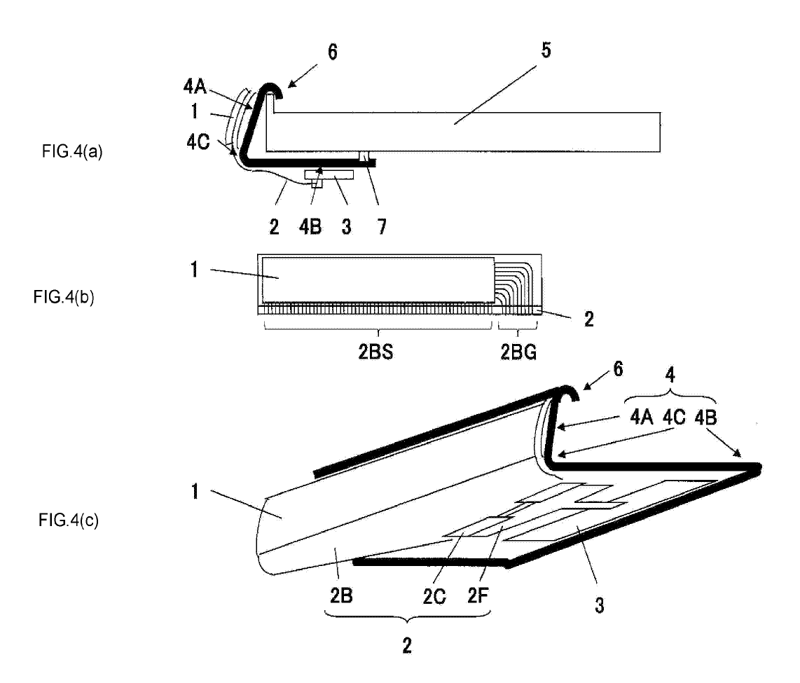

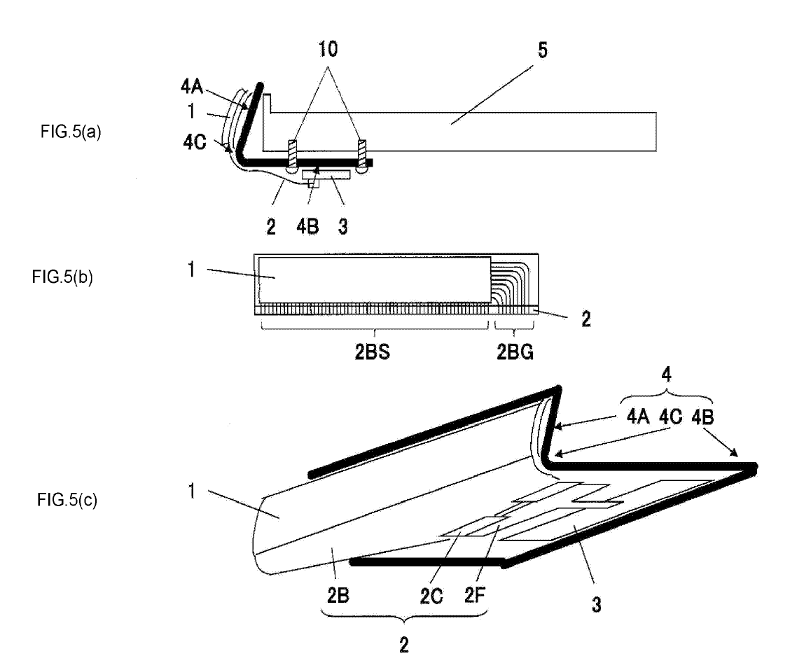

FIGS. 4(a)-4(c) are views showing the configuration of the display panel according to another embodiment of the present invention. FIG. 4(a) is a cross-sectional view, FIG. 4(b) is a front view, and FIG. 4(c) is a perspective view. The display panel includes the display part 1, the wiring part 2, and the driving part 3. As shown in FIG. 4(a), the display panel is attached to the shelf board 5. The display part 1 is attached to the front surface side of the shelf board 5, and inclines upward in a range of 5° to 30°. Thereby, the display part 1 can be seen from above the shelf board 5 with high visibility. Here, the range of 5° to 30° is a range of the angle between a plane including the upper edge and the lower edge of the display part 1, and the front surface of the shelf board 5. In addition, the wiring part 2 extending from the display part 1 is bent in the vicinity of the lower edge of the display part 1 in a range of 95° to 120°, and is disposed at the lower surface side of the shelf board 5 along the shelf board 5. Here, the range of 95° to 120° is a range of the angle between a plane including the upper edge and the lower edge of the display area, and a plane of most of the wiring part 2. In addition, the wiring part 2 includes the source wiring extending from the lower edge of the display part 1 and the gate wiring extending from the right edge of the display part and curved downward. In FIG. 4(a), the display part 1 has a curved surface shape curved with respect to the vertical direction. According to the curved surface shape, even a slightly curved surface having a large curvature radius is felt to be soft in appearance. Thereby, the favorability rating of the commodity increases, which provides an effect of increasing purchasing willingness of consumers. In addition, the curved surface shape provides an advantage that the upper part of the display part 1 easily receives light from the ceiling, which makes indication of the display part 1 bright.

The wiring part 2 may include not only the simple wiring (2B) but also the driver IC (2C) and the flexible printed board (2F). The driving part 3 has at least a control circuit for performing display driving. The driving part 3 may further have an internal memory and an interface with an external database.

To dispose the display part 1, the wiring part 2, and the driving part 3 as described above, a rigid base 4 is used. The base 4 is a member for keeping the positions of the display part 1, the wiring part 2, and the driving part 3. The base 4 includes the front part 4A to which the display part 1 is fixed, the planar part 4B to which the wiring part 2 and the driving part 3 are fixed, and the bent part 4C that has a predetermined curvature radius and joins the front part and the planar part to each other. The fixing portion of the wiring part 2 and the driving part 3 may be on the lower surface or the upper surface of the planar part 4B. The material of the base 4 may be metal, plastic, or a combination thereof. The display part 1, the wiring part 2, and the driving part 3 are fixed to the base 4 by an adhesive, single-sided adhesive tape, double-sided adhesive tape, screws, or the like, which are not shown in FIGS. 4(a)-4(c). The bent part 4C of the base 4 has a certain curvature radius or larger. Even when the flexible wiring part 2 is fixed along the base 4, a certain curvature radius or larger of the wiring part 2 is kept, whereby wiring resistance can be prevented from increasing due to bending. In FIG. 4(a), the front portion of the base 4 has a shape curved with respect to the vertical direction. Thus, the display part 1 is curved by placing the flexible display part 1 along the base 4.

The base 4 has the hook part 6 on the back side of the upper edge of the display part 1. Hanging the hook part 6 on the upper edge of the front surface of the shelf board 5 can prevent the display panel from being displaced downward or frontward. In addition, the base 4 has a magnet 7 provided on the planar part 4B in the vicinity of the wiring part 2 or the driving part 3. When the shelf board 5 is made of magnetic metal, the magnet 7 sticks to the shelf board 5, whereby the wiring part 2 and driving part 3 are prevented from dangling.

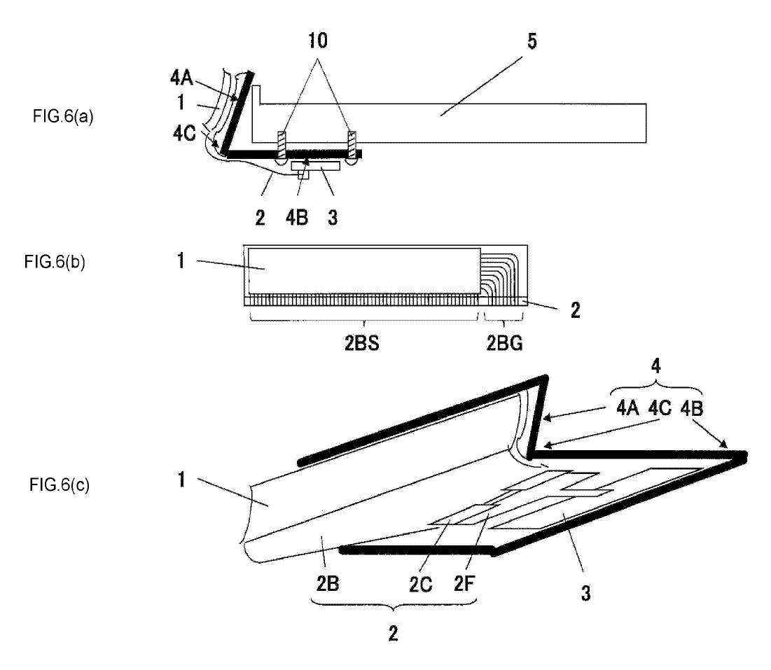

FIGS. 5(a)-6(c) are views showing modifications of the display panel shown in FIGS. 4(c)-4(c). FIG. 5(a) and FIG. 6(a) are cross-sectional views, FIG. 5(b) and FIG. 6(b) are front views, and FIG. 5(c) and FIG. 6(c) are perspective views. The display panel includes the display part 1, the wiring part 2, and the driving part 3. As shown in FIG. 5(a) and FIG. 6(a), the display panel according to the present embodiment is attached to the shelf board 5. The display part 1 is attached to the front surface side of the shelf board 5, and inclines upward in a range of 5° to 30°. Thereby, the display part 1 can be seen from above the shelf board 5 with high visibility. Here, the range of 5° to 30° is a range of the angle between a plane including the upper edge and the lower edge of the display part 1, and the front surface of the shelf board 5. In addition, the wiring part 2 extending from the display part 1 is bent in the vicinity of the lower edge of the display part 1 in a range of 95° to 120°, and is disposed at the lower surface side of the shelf board 5 along the shelf board 5. Here, the range of 95° to 120° is a range of the angle between a plane including the upper edge and the lower edge of the display part 1, and a plane of most of the wiring part 2. In addition, the wiring part 2 includes the source wiring extending from the lower edge of the display part 1 and the gate wiring extending from the right edge of the display part and curved downward. In FIGS. 5(a) and 6(a), the display part 1 has a curved surface shape curved with respect to the vertical direction. FIGS. 5(a)-5(c) show a convex shape, and FIGS. 6(a)-6(c) show a concave shape. According to the curved surface shape, even a slightly curved surface having a large curvature radius is felt to be soft in appearance. Thereby, the favorability rating of the commodity increases, which provides an effect of increasing purchasing willingness of consumers. In addition, in the case of the example shown in FIGS. 5(a)-5(c), the curved surface shape provides an advantage that the upper part of the display part 1 easily receives light from the ceiling, which makes indication of the display part 1 bright. In the case of the example shown in FIGS. 6(a)-6(c), it is possible to make the display part 1 easily viewable from above and difficult to be seen from underneath. Specifically, it is possible to display a comment, which is intended to be seen only by adults, at the lower portion of the display part 1. The wiring part 2 may include not only the simple wiring (2B) but also the driver IC (2C) and the flexible printed board (2F). The driving part 3 has at least a control circuit for performing display driving. The driving part 3 may further have an internal memory and an interface with an external database.

To dispose the display part 1, the wiring part 2, and the driving part 3 as described above, a rigid base 4 is used. The base 4 is a member for keeping the positions of the display part 1, the wiring part 2, and the driving part 3. The base 4 includes the front part 4A to which the display part 1 is fixed, the planar part 4B to which the wiring part 2 and the driving part 3 are fixed, and the bent part 4C that has a predetermined curvature radius and joins the front part and the planar part to each other. The fixing portion of the wiring part 2 and the driving part 3 may be on the lower surface or the upper surface of the planar part 4B. The material of the base 4 may be metal, plastic, or a combination thereof. The display part 1, the wiring part 2, and the driving part 3 are fixed to the base 4 by an adhesive, single-sided adhesive tape, double-sided adhesive tape, screws, or the like, which are not shown in FIGS. 5(a)-5(c) and FIGS. 6(a)-6(c). The bent part 4C of the base 4 has a certain curvature radius or larger. Even when the flexible wiring part 2 is fixed along the base 4, a certain curvature radius or larger of the wiring part 2 is kept, whereby wiring resistance can be prevented from increasing due to bending. In FIG. 5(a) and FIG. 6(a), the front portion of the base 4 has a shape curved with respect to the vertical direction. Thus, the display part 1 is curved by placing the flexible display part 1 along the base 4.

In the present modification, although the base 4 does not have the hook part 6 which is shown in FIGS. 1(a) to 4(c), and also does not have the magnet 7, the base 4 can be fixed to the shelf board 5 by screws or the like (in this case, the shelf board 5 is not necessary to be made of magnetic metal).

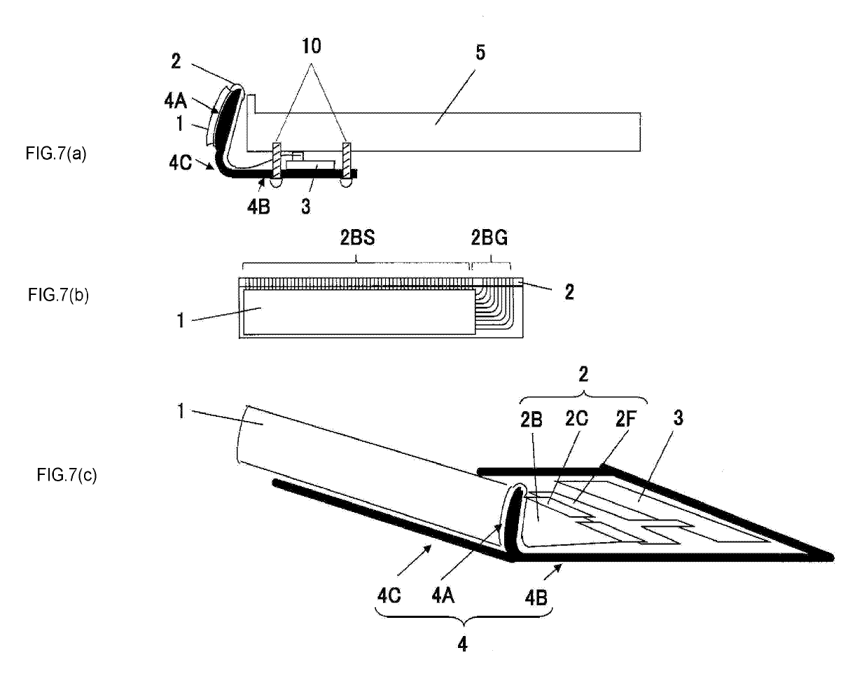

FIGS. 7(a)-7(c) are views showing another modification of the display panel shown in FIGS. 4(a)-4(c). FIG. 7(a) is a cross-sectional view, FIG. 7(b) is a front view, and FIG. 7(c) is a perspective view. The display panel includes the display part 1, the wiring part 2, and the driving part 3. As shown in FIG. 7(a), the display panel is attached to the shelf board 5. The display part 1 is attached to the front surface side of the shelf board 5, and inclines upward in a range of 5° to 30°. Thereby, the display part 1 can be seen from above the shelf board 5 with high visibility. Here, the range of 5° to 30° is a range of the angle between a plane including the upper edge and the lower edge of the display part 1, and the front surface of the shelf board 5. In addition, the wiring part 2 extending upward from the display part 1 is bent in the vicinity of the upper edge of the display part 1 at approximately 180°, and is further bent in the vicinity of the lower edge of the display part 1 in a range of 95° to 120°. Then the wiring part 2 is disposed at the lower surface side of the shelf board 5 and is along the shelf board 5. Here, the approximately 180° is an angle between a plane including the upper edge and the lower edge of the display area, and a plane of the wiring part 2 of the back of the base. The range of 95° to 120° is a range of the angle between a plane of the wiring part 2 of the back of the base 4 and a plane of the wiring part 2 on the top surface of the base 4. In addition, the wiring part 2 includes the source wiring extending from the upper edge of the display part 1 and the gate wiring extending from the right edge of the display part and curved upward. In FIG. 7(a), the display part 1 has a curved surface shape curved with respect to the vertical direction. According to the curved surface shape, even a slightly curved surface having a large curvature radius is felt to be soft in appearance. Thereby, the favorability rating of the commodity increases, which provides an effect of increasing purchasing willingness of consumers. In addition, the curved surface shape provides an advantage that the upper part of the display part 1 easily receives light from the ceiling, which makes indication of the display part 1 bright. The wiring part 2 may include not only the simple wiring (2B) but also the driver IC (2C) and the flexible printed board (2F). The driving part 3 has at least a control circuit for performing display driving. The driving part 3 may further have an internal memory and an interface with an external database.

To dispose the display part 1, the wiring part 2, and the driving part 3 as described above, the rigid base 4 is used. The base 4 is a member for keeping the positions of the display part 1, the wiring part 2, and the driving part 3. The base 4 includes the front part 4A to which the display part 1 is fixed, the planar part 4B on the upper surface of which the wiring part 2 and the driving part 3 are fixed, and the bent part 4C that has a predetermined curvature radius and joins the front part and the planar part to each other. The fixing portion of the wiring part 2 and the driving part 3 may be on the lower surface of the planar part 4B. The material of the base 4 may be metal, plastic, or a combination thereof. The display part 1, the wiring part 2, and the driving part 3 are fixed to the base 4 by an adhesive, single-sided adhesive tape, double-sided adhesive tape, screws, or the like, which are not shown in FIGS. 7(a)-7(c). The bent part 4C of the base 4 has a certain curvature radius or larger. Even when the flexible wiring part 2 is fixed along the base 4, a certain curvature radius or larger of the wiring 2 is kept, whereby wiring resistance can be prevented from increasing due to bending. In FIG. 7(a), the front portion of the base 4 has a shape curved with respect to the vertical direction. Thus, the display part 1 is curved by placing the flexible display part 1 along the base 4.

Although the base 4 does not have the hook part 6 which are shown in FIGS. 1(a) to 4(c), and also does not have the magnet 7, the base 4 can be fixed to the shelf board 5 by screws or the like (in this case, the shelf board 5 is not necessary to be made of magnetic metal).

In addition, another embodiment of the present invention provides a large-sized display panel that is configured by using a plurality of display panels, which are described above, and arranging two of the adjacent display panels so that, a wiring part (gate wiring) of the display panel and the left edge or the right edge of the display part of the other display panel overlap with each other.

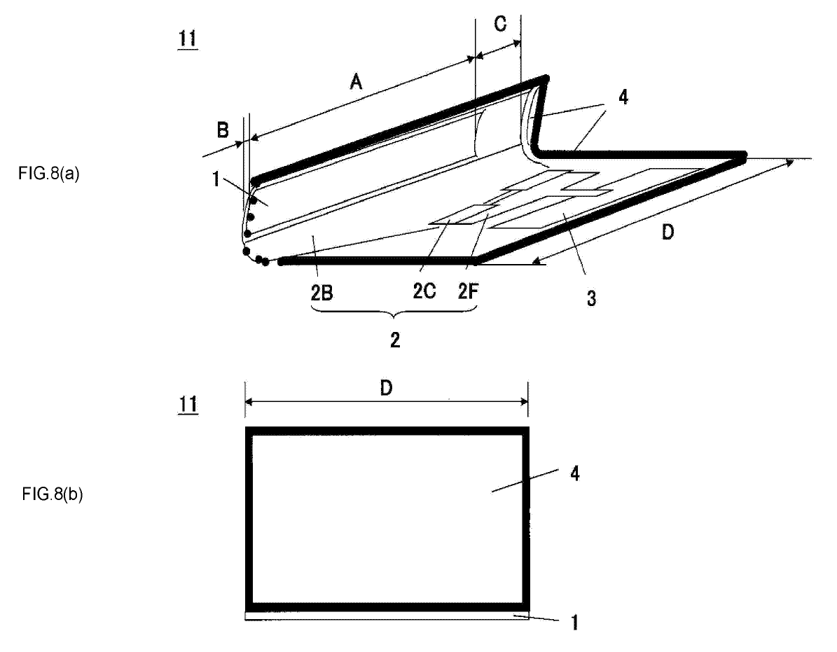

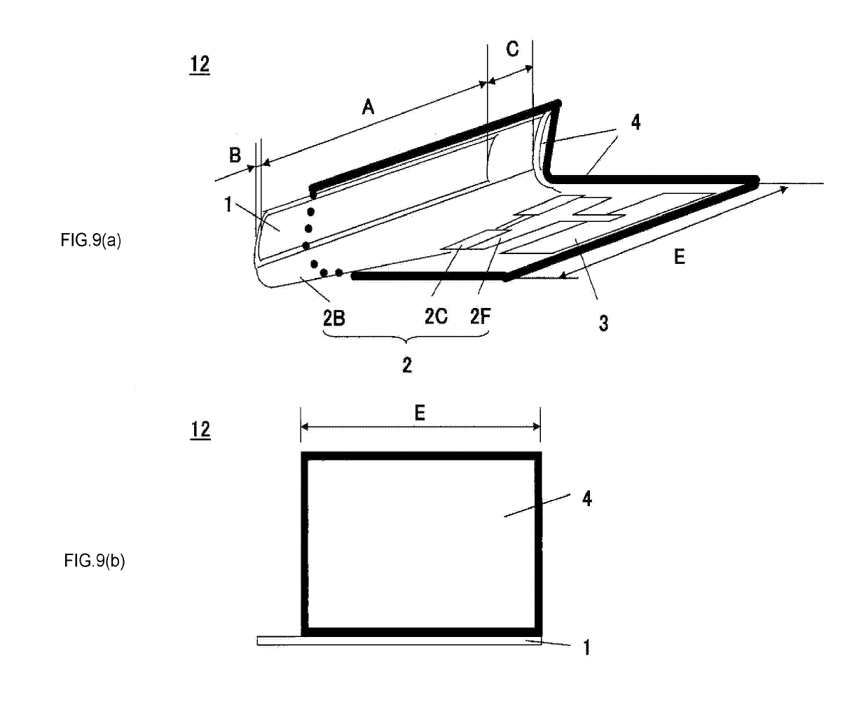

Two types of display panels for configuring the large-sized display panel are shown in FIGS. 8(a)-9(b). The display part 1 has, in addition to an area width A for actual display, non-display area widths B and C. Since the display panel includes, in addition to the source wiring extending from the upper edge or the lower edge of the display part 1, the gate wiring extending from the right edge or the left edge of the display part 1 and curved upward or downward, the non-display area width C in which the gate wiring is present is larger than the non-display area width B in which the gate wiring is not present.

The combination of a panel 11 shown in FIGS. 8(b) and 8(b) and a panel 12 shown in FIGS. 9(a) and 9(b) configure the large-sized display panel. As shown in FIGS. 8(a) and 8(b), the panel 11 has the base 4 having a width D approximately equal to A+B+C. The whole display part 1 is fixed to the base 4.

Meanwhile, the panel 12 shown in FIGS. 9(a) and 9(b) has the base 4 having a width E approximately equal to A+B. Although most of the display part 1 is fixed to the base 4, part of the display part 1 is not fixed.

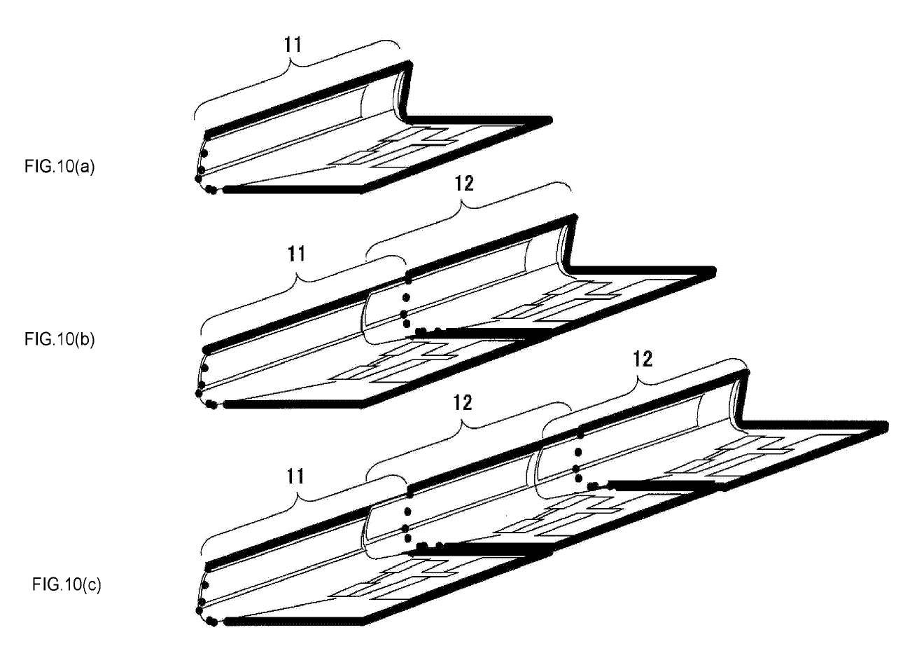

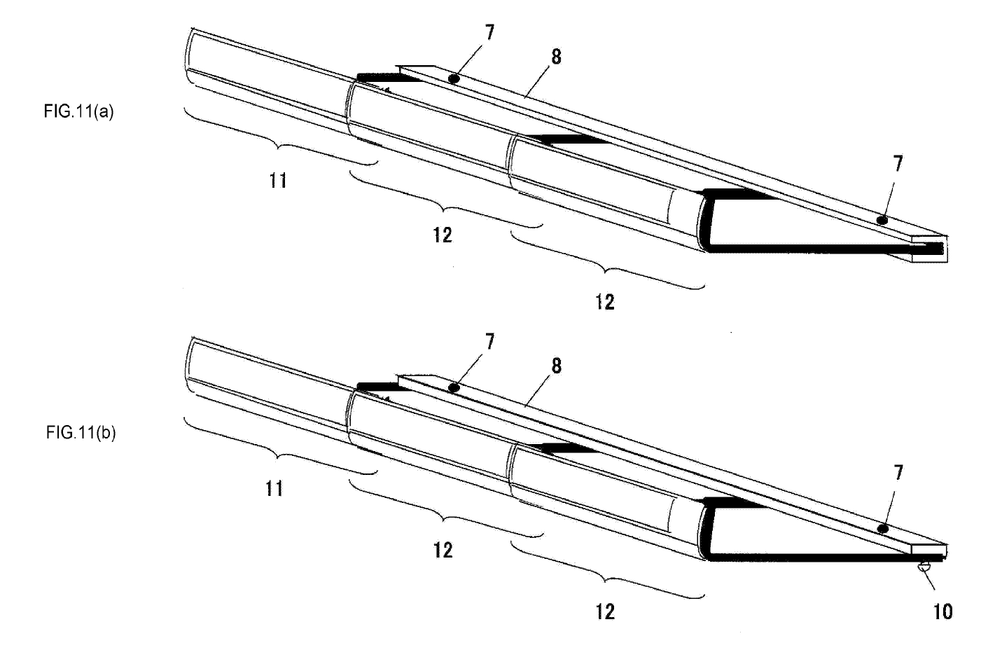

The large-sized display panel using the above parts is shown in FIGS. 10(a)-10(c). When the large-sized display panel configured by combining N display panels is produced, one panel 11 and N-1 panels 12 are used. First, the panel 11 is prepared (FIG. 10(a)), and then the panel 12 is made to overlap with the panel 11 so as to cover the non-display area width C of the panel 11 (FIG. 10(b)). Furthermore, another panel 12 is made to overlap with the panel 12 so as to cover the non-display area width C of the panel 12 (FIG. 10(c)). Repeating the same process can produce the large-sized display panel using the N display panels. In addition, as a result, the non-display areas between the plurality of display panels are only the area widths B. Thereby, the display panels can be considered almost continuous. Specifically, when the non-display area width B is smaller than the size of one pixel, the display panels can be considered completely continuous.

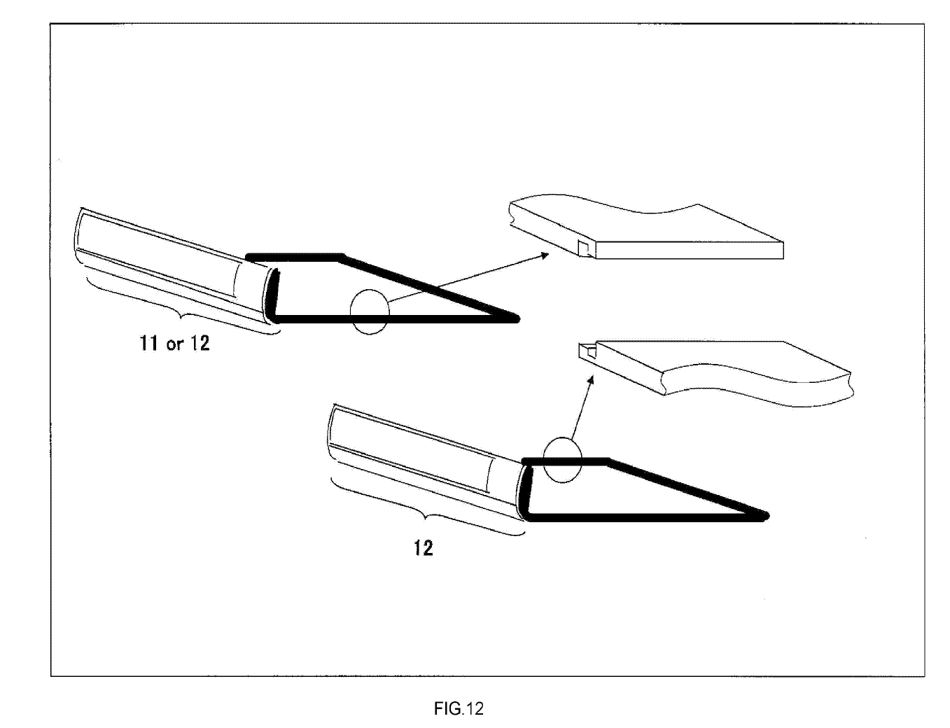

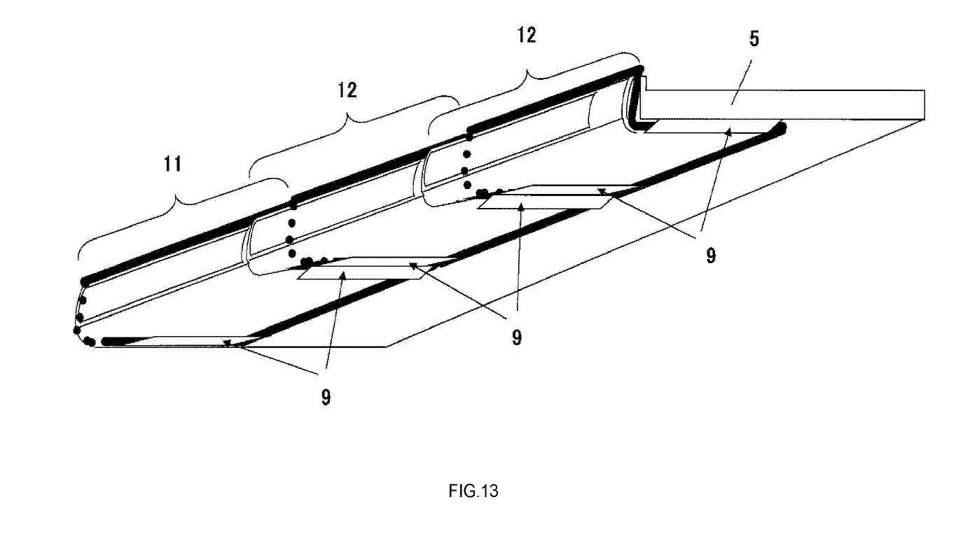

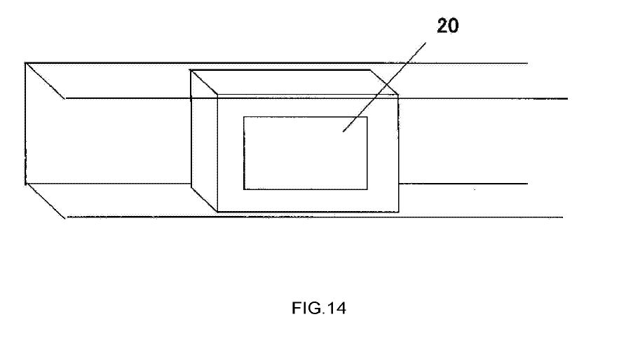

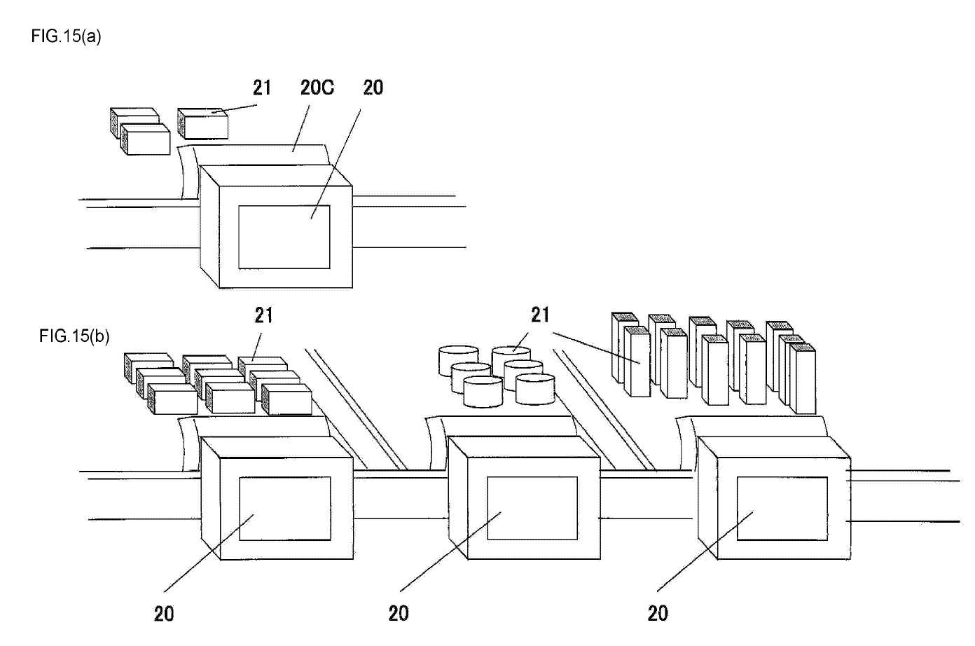

The plurality of bases 4 may be connected by another single connecting component. Alternatively, the bases 4 may have a structure that can join the bases 4 to each other. FIGS. 11(a)-13 show connection examples of the large-sized display panel. For example, as shown in FIG. 11(a), the plurality of bases 4 can be connected by inserting them into a connecting component 8. Alternatively, as shown in FIG. 11(b), the plurality of bases 4 can be connected by fixing them to the connecting component 8 by screws. As shown in FIG. 12, the bases 4 can be connected to each other by fitting concave-convex grooves provided in the bases 4 into each other.

When the bases 4 of the display panels have the hook parts 6, it is desirable that all the display panels have the respective hook parts 6. However, only some display panels may have the respective display panels. The magnets 7 may be provided not in the respective bases 4 but in the connecting component 8.

Alternatively, as shown in FIG. 13, receiving parts 9 into which the bases 4 can be inserted may be provided on the underside of the shelf board 5 so that the bases 4 of the display panels are inserted into the receiving parts 9 to be fixed.

According to the large-sized display panel described above, the display parts 1 form a display part as the large-sized display panel, which has a large width, for example equals to the width of the shelf board 5 across the whole front surface of the shelf board 5. Hence, the display can be freely divided depending on installation widths of commodities, which provides an advantage that the number of the electronic shelf labels is not required to be increased and decreased depending on the number of types of commodities.

The wiring part 2 is preferably flexible. In the configuration in which the display part 1 is curved, the display part 1 is also preferably flexible. In addition, to form the large-sized display panel, the thickness of the display part 1 is preferably small. Hence, a polymer dispersed liquid crystal or electrophoretic display is suitable for the display part 1. The polymer dispersed liquid crystal or electrophoretic display can be prepared by using a plastic base material and can be flexible and thin.

It is important that the base 4 has the strength to maintain the structure thereof and is light in weight. Hence, a metal including aluminum as a main component or resin is preferable. It is preferable that the whole base 4 is made of injection-molded resin, the whole base 4 is formed by bending an aluminum board, or the base 4 is formed by bonding resin to the bent aluminum board or fixing the resin to the bent aluminum board by screws.

Since the display panel does not include the driving part 3 at the back of the display part 1 but is provided under the shelf board 5, the display part 1 can be small in thickness and low in height. Hence, the display panel can display information while the commodities can be easily seen. In addition, the display panel can be prevented from being easily detached and damaged due to dropping. Furthermore, the display parts 1 can be connected in a long width. Extending the display area across the whole width of the shelf board can perform display depending on installation widths of commodities without arranging individual display panels as same as the number of types of the commodities, then simple display can be performed.

### EXAMPLE 1

Next, specific examples will be described.

The display panel shown in FIGS. 1(a)-1(c) was produced. First, a thin-film transistor array using oxide semiconductors was formed on a PEN substrate, and polymer dispersed liquid crystals were sandwiched between the resultant substrate and a PET substrate having a transparent electrode to form the display part 1. The length in the longitudinal direction of the display part 1 was 20 mm. The wiring 2B extending from the display part 1 included the PEN substrate and an ITO electrode thereon. The driver IC (2C) was bonded to the wiring 2B with ACF, and the flexible printed board (2F) was bonded to the driver IC (2C), whereby the wiring part 2 was formed. An aluminum sheet having a thickness of 1 mm was bent to form the base 4. The magnet 7 was fixed to the base 4 by adhesive. The curvature radius of the bent part 4C was set to 5 mm. The display part 1 was fixed to the front part 4A of the base 4. The wiring part 2 was fixed along the bent part 4C of the base 4. The driving part 3 was fixed to the planar part 4B of the base 4 by screws. The front edge of the flexible printed board 2F was connected to a connector of the driving part 3. The hook part 6 of the base 4 was hung on the upper edge of the front surface of the shelf board 5, and then the magnet 7 was fixed to the lower surface of the shelf board 5, whereby the display panel was installed to the shelf board 5.

According to the display panel produced as described above, since the display part 1 and the base front part 4A had small thicknesses and low heights approximately equal to the thickness of the shelf board 5, commodities on the shelf board 5 were able to be seen easily.

### EXAMPLE 2

The display panel shown in FIGS. 2(a)-2(c) was produced. First, a thin-film transistor array using organic semiconductors was formed on a PEN substrate, and electrophoretic bodies were sandwiched between the resultant substrate and a PET substrate having a transparent electrode to form the display part 1. The length in the longitudinal direction of the display part 1 was 20 mm. The wiring 2B extending from the display part 1 included the PEN substrate and an electrode thereon. The driver IC (2C) was bonded to the wiring 2B with ACF, and the flexible printed board 2F was bonded to the driver IC (2C), whereby the wiring part 2 was formed. An aluminum sheet having a thickness of 1 mm was bent. A semielliptic cylindrical resin component was bonded to the front surface of the aluminum sheet to form the base 4. Furthermore, the magnet 7 was fixed to the base 4 by adhesive. The curvature radius of the bent part 4C was set to 2 mm. The thickness of the central part of the semielliptic cylindrical resin component was set to 1 mm. The display part 1 was fixed to the front part 4A of the base 4. The wiring part 2 was fixed along the bent part 4C of the base 4. The driving part 3 was fixed to the planar part 4B of the base 4 by screws. The front edge of the flexible printed board 2F was connected to a connector of the driving part 3. The hook part 6 of the base 4 was hung on the upper edge of the front surface of the shelf board 5, and then the magnet 7 was fixed to the lower surface of the shelf board 5, whereby the display panel was installed to the shelf board 5.

According to the display panel produced as described above, since the display part 1 and the base front part 4A had small thicknesses and low heights approximately equal to the thickness of the shelf board 5, commodities on the shelf board 5 was able to be seen easily. In addition, since the display part was curved, a soft impression was created.

### EXAMPLE 3

The display panel shown in FIGS. 3(a)-3(c) was produced. First, a thin-film transistor array using organic semiconductors was formed on a PEN substrate, and electrophoretic bodies were sandwiched between the resultant substrate and a PET substrate having a transparent electrode to form the display part 1. The length in the longitudinal direction of the display part 1 was 20 mm. The wiring 2B extending from the display part 1 included the PEN substrate and an electrode thereon. The driver IC (2C) was bonded to the wiring 2B with ACF, and the flexible printed board 2F was bonded to the driver IC, whereby the wiring part 2 was formed. An aluminum sheet having a thickness of 1 mm was bent to form the base 4. The magnet 7 was fixed to the base 4 by adhesive. The curvature radius of the bent part 4C was set to 2 mm. The angle between the front surface and the lower surface of the bent part 4C was set to 110°. The display part 1 was fixed to the front part 4A of the base 4. The wiring part 2 was fixed along the bent part 4C of the base 4. The driving part 3 was fixed to the planar part 4B of the base 4 by screws. The front edge of the flexible printed board 2F was connected to a connector of the driving part 3. The hook part 6 of the base 4 was hung on the upper edge of the front surface of the shelf board 5, and then the magnet 7 was fixed to the lower surface of the shelf board 5, whereby the display panel was installed to the shelf board 5.

According to the display panel produced as described above, since the display part 1 and the base front part 4A had small thicknesses and low heights approximately equal to the thickness of the shelf board 5, commodities on the shelf board 5 were able to be seen easily. In addition, since the display part was directed slightly upward, the display was able to be seen easily.

### EXAMPLE 4

The display panel shown in FIGS. 4(a)-4(c) was produced. First, a thin-film transistor array using organic semiconductors was formed on a PEN substrate, and electrophoretic bodies were sandwiched between the resultant substrate and a PET substrate having a transparent electrode to form the display part 1. The length in the longitudinal direction of the display part 1 was 20 mm. The wiring 2B extending from the display part 1 included the PEN substrate and an electrode thereon. The driver IC (2C) was bonded to the wiring 2B with ACF, and the flexible printed board 2F was bonded to the driver IC (2C), whereby the wiring part 2 was formed. An aluminum sheet having a thickness of 1 mm was bent. A semielliptic cylindrical resin component was bonded to the front surface of the aluminum sheet to form the base 4. Furthermore, the magnet 7 was fixed to the base 4 by adhesive. The curvature radius of the bent part 4C was set to 2 mm. The angle between the front surface and the lower surface of the bent part 4C was set to 110°. The thickness of the central part of the semielliptic cylindrical resin component was set to 1 mm. The display part 1 was fixed to the front part 4A of the base 4. The wiring part 2 was fixed along the bent part 4C of the base 4. The driving part 3 was fixed to the planar part 4B of the base 4 by screws. The front edge of the flexible printed board 2F was connected to a connector of the driving part 3. The hook part 6 of the base 4 was hung on the upper edge of the front surface of the shelf board 5, and then the magnet 7 was fixed to the lower surface of the shelf board 5, whereby the display panel was installed to the shelf board 5.

According to the display panel produced as described above, since the display part 1 and the base front part 4A had small thicknesses and low heights approximately equal to the thickness of the shelf board 5, commodities on the shelf board 5 were able to be seen easily. In addition, since the display part was directed slightly upward, the display was able to be seen easily. Furthermore, since the display part was curved, a soft impression was created.

### EXAMPLE 5

The display panel shown in FIGS. 5(a)-5(c) was produced. First, a thin-film transistor array using organic semiconductors was formed on a PEN substrate, and electrophoretic bodies were sandwiched between the resultant substrate and a PET substrate having a transparent electrode to form the display part 1. The length in the longitudinal direction of the display part 1 was 15 mm. The wiring 2B extending from the display part 1 included the PEN substrate and an electrode thereon. The driver IC (2C) was bonded to the wiring 2B with ACF, and the flexible printed board 2F was bonded to the driver IC, whereby the wiring part 2 was formed. An aluminum sheet having a thickness of 1 mm was bent. A semielliptic cylindrical resin component was bonded to the front surface of the aluminum sheet to form the base 4. The curvature radius of the bent part 4C was set to 1 mm. The angle between the front surface and the lower surface of the bent part 4C was set to 120°. The thickness of the central part of the semielliptic cylindrical resin component was set to 1 mm. The display part 1 was fixed to the front part 4A of the base 4. The wiring part 2 was fixed along the bent part 4C of the base 4. The driving part 3 was fixed to the planar part 4B of the base 4 by screws. The front edge of the flexible printed board 2F was connected to a connector of the driving part 3. The base 4 was fixed to the shelf board 5 by screws to install the display panel to the shelf board 5.

According to the display panel produced as described above, since the display part 1 and the base front part 4A had small thicknesses and low heights approximately equal to the thickness of the shelf board 5, commodities on the shelf board 5 were able to be seen easily. In addition, since the display part was directed slightly upward, the display was able to be seen easily. Furthermore, since the display part was curved, a soft impression was created.

### EXAMPLE 6

The display panel shown in FIGS. 6(a)-6(c) was produced. First, a thin-film transistor array using organic semiconductors was formed on a PEN substrate, and electrophoretic bodies were sandwiched between the resultant substrate and a PET substrate having a transparent electrode to form the display part 1. The length in the longitudinal direction of the display part 1 was 15 mm. The wiring 2B extending from the display part 1 included the PEN substrate and an electrode thereon. The driver IC (2C) was bonded to the wiring 2B with ACF, and the flexible printed board 2F was bonded to the driver IC, whereby the wiring part 2 was formed. Separately, resin was injection-molded to form the base 4. The curvature radius of the bent part 4C was set to 1 mm. The angle between the front surface and the lower surface of the bent part 4C was set to 120°. The curvature radius of the front surface was 70 mm. The display part 1 was fixed to the front part 4A of the base 4. The wiring part 2 was fixed along the bent part 4C of the base 4. The driving part 3 was fixed to the planar part 4B of the base 4 by screws. The front edge of the flexible printed board 2F was connected to a connector of the driving part 3. The base 4 was fixed to the shelf board 5 by screws to install the display panel to the shelf board 5.

According to the display panel produced as described above, since the display part 1 and the base front part 4A had small thicknesses and low heights approximately equal to the thickness of the shelf board 5, commodities on the shelf board 5 was able to be seen easily. In addition, since the display part was directed slightly upward, the display was able to be seen easily. Furthermore, since the display part was curved, a soft impression was created.

### EXAMPLE 7

The display panel shown in FIGS. 7(a)-7(c) was produced. First, a thin-film transistor array using organic semiconductors was formed on a PEN substrate, and electrophoretic bodies are sandwiched between the resultant substrate and a PET substrate having a transparent electrode to form the display part 1. The length in the longitudinal direction of the display part 1 was 15 mm. The wiring 2B extending from the display part 1 included the PEN substrate and an electrode thereon. The driver IC (2C) was bonded to the wiring 2B with ACF, and the flexible printed board 2F was bonded to the driver IC (2C), whereby the wiring part 2 was formed. An aluminum sheet having a thickness of 1 mm was bent. A semielliptic cylindrical resin component was bonded to the front surface of the aluminum sheet to form the base 4. The curvature radius of the bent part 4C was set to 1 mm. The angle between the front surface and the lower surface of the bent part 4C was set to 95°. The thickness of the central part of the semielliptic cylindrical resin component was set to 1 mm. The display part 1 was fixed to the front part 4A of the base 4. The wiring part 2 was fixed from the front surface to the rear surface of the base 4 and further along the inside of the bent part 4C. The driving part 3 was fixed to the planar part 4B of the base 4 by screws. The front edge of the flexible printed board 2F was connected to a connector of the driving part 3. The base 4 was fixed to the shelf board 5 by screws to install the display panel to the shelf board 5.

According to the display panel produced as described above, since the display part 1 and the base front part 4A had small thicknesses and low heights approximately equal to the thickness of the shelf board 5, commodities on the shelf board 5 were able to be seen easily. In addition, since the display part is directed slightly upward, the display was able to be seen easily. Furthermore, since the display part was curved, a soft impression was created.

### EXAMPLE 8

One display panel 11 shown in FIGS. 8(a) and 8(b) and two display panels 12 shown in FIGS. 9(a) and 9(b) were produced by the method of the example 4, where A=100 mm, B=1 mm, C=15 mm, D=116 mm, and E=101 mm.

Next, the combination shown in FIGS. 10(a)-10(c) formed a large-sized display panel having a total width of 318 mm. Furthermore, as shown in FIG. 11(b), the bases are fixed to the connecting component 8 (made of aluminum) including the magnets 7 by screws. The hook parts 6 were hung on the upper edge of the front surface of the shelf board 5, and then the magnets 7 were fixed to the lower surface of the shelf board 5, whereby the large-sized display panel was fixed on the shelf board 5.

Freely dividing the display depending on installation widths of commodities resulted in no need for increasing and decreasing the number of electronic shelf labels depending on the number of types of the commodities.

An aspect of the present invention is to provide a display panel whose thickness or height is reduced while an information display function is maintained, in addition to provide a display panel that is difficult to be damaged due to dropping.

One embodiment of the present invention is a display panel that is installed to a shelf board to display information. The display panel includes a display part that is disposed to a front surface of the shelf board and displays the information, a driving part that is disposed at an underside of the shelf board along the shelf board and drives the display part, and a wiring part that extends from an outer periphery of the display part and is bent from a lower edge or an upper edge of the front surface of the shelf board toward the underside, to connect the display part and the driving part.

In addition, the wiring part may be bent in the vicinity of a lower edge of the display part and at an angle of 90° or more and 120° or less.

In addition, the wiring part may include a source wiring extending from a lower edge or an upper edge of the display part and a gate wiring extending from a left edge or a right edge of the display part and curved downward or upward.

In addition, the display part may be fixed to a front part of a rigid base, the wiring part and the driving part may be fixed to an upper surface or a lower surface of a planar part of the rigid base, the front part and the planar part of the rigid base may be joined to each other via a bent part having a predetermined curvature radius, and the wiring part may be bent along the bent part.

In addition, the display part may incline from the front surface of the shelf board upward at an angle of 5° or more and 30° or less.

In addition, a display surface of the display part may be a curved surface curved with respect to a vertical direction.

In addition, the display part may be a polymer dispersed liquid crystal display or an electrophoretic display.

In addition, the display panel may have a hook part on a back side of an upper edge of the display part, and the hook part may be hung on the upper edge of the front surface of the shelf board.

In addition, the display panel may have a magnet in the vicinity of the wiring part or the driving part, and the wiring part and the driving part may be fixed to the shelf board by the magnet.

In addition, another aspect of the present invention is a large-sized display panel that is configured by using a plurality of display panels described above, and arranging two of the adjacent display panels so that the wiring part of one of the display panels and a left edge or a right edge of the display part of the other panel overlap with each other.

In addition, a width of a display part, which is configured by the display parts of the plurality of display panels and serves as the large-sized display panel, may be equal to a width of the shelf board.

In addition, the large-sized display panel may be configured by combining two types of the display panels including the respective bases whose widths differ from each other.

In addition, the large-sized display panel may have a connecting component connecting the plurality of display panels, the connecting component may have a magnet, and the wiring part and the driving part may be fixed to the shelf board by the magnet.

In addition, the bases may have structures for joining the bases to each other to integrate the plurality of display panels.

In addition, the bases may be inserted into receiving parts provided to the shelf board to integrate the plurality of display panels. According to the present application, a display panel can be provided whose thickness or height is reduced while an information display function is maintained. In addition, a display panel can be provided which is difficult to be damaged due to dropping.

### INDUSTRIAL APPLICABILITY

The present invention relates to a display panel, such as an electronic shelf label, using a liquid crystal display (LCD), electronic paper, or the like.

### REFERENCE SIGNS LIST

1 display part

2 wiring part

2B simple wiring part

2BG gate wiring

2BS source wiring

2C IC

2F flexible printed board

3 driving part

4 base

4A front part

4B planar part

4C bent part

5 shelf board

6 hook part

7 magnet

8 connecting component

9 receiving part

10 screw

11 panel

12 panel

20 conventional electronic shelf label

21 commodities
Obviously, numerous modifications and variations of the present invention are possible in light of the above teachings. It is therefore to be understood that within the scope of the appended claims, the invention may be practiced otherwise than as specifically described herein.

What is claimed is:

1. A display panel for a shelf board, comprising:
a display part which displays the information and is configured to be placed on a front surface of a shelf board;
a driving part which drives the display part and is configured to be placed on an underside of the shelf board along the shelf board; and
a wiring part connecting the display part and the driving part,
wherein the wiring part extends from an outer periphery of the display part and is bent from a lower edge portion or an upper edge portion of the front surface toward the underside of the shelf board.

2. The display panel of claim 1, wherein the wiring part is bent in a vicinity of a lower edge portion of the display part at an angle of from 90° to 120°.

3. The display panel of claim 1, wherein the wiring part is bent from the upper edge portion of the front surface toward the underside of the shelf board.

4. The display panel of claim 1, wherein the wiring part includes a source wiring extending from a lower edge portion or an upper edge portion of the display part, and
a gate wiring extending from a left edge portion or a right edge portion of the display part and curved downward or upward.

5. The display panel of claim 4, wherein the source wiring extends from the upper edge portion of the display part, and the gate wiring is curved upward.

6. The display panel of claim 1, further comprising:
a base having a front part, a planar part, and a bent part connecting the front part and the planar part,
wherein the display part is positioned on the front part, the wiring part and the driving part are positioned on an upper surface or a lower surface of the planar part, and the wiring part is bent along the bent part.

7. The display panel of claim 5, further comprising:
a base having a front part, a planar part, and a bent part connecting the front part and the planar part,
wherein the display part is positioned on the front part, the wiring part and the driving part are positioned on an upper surface of the planar part, and the wiring part is bent along the bent part.

8. The display panel of claim 1, wherein the display part is inclined upward at an angle of from 5° to 30° from the front surface of the shelf board.

9. The display panel of claim 1, wherein the display part has a display surface curved with respect to a vertical direction.

10. The display panel of claim 9, wherein the display surface has a convex shape.

11. The display panel of claim 9, wherein the display surface has a concave shape.

12. The display panel of claim 1, wherein the display part comprises a polymer dispersed liquid crystal display or an electrophoretic display.

13. The display panel of claim 1, further comprising:
a hook part positioned on a back side of an upper edge of the display part, and configured to be hung on the upper edge portion of the front surface of the shelf board.

14. The display panel of claim 1, further comprising:
a magnet positioned in a vicinity of the wiring part or the driving part such that the magnet fixes the wiring part and the driving part to the shelf board.

15. A large-sized display panel, comprising:
a plurality of display panels each of which is the display panel of claim 1,
wherein two adjacent ones of the display panels are positioned such that the wiring part of one of the display panels overlaps with a left edge or a right edge of the display part of the other of the display panels.

16. The large-sized display panel of claim 15, wherein the display parts of the display panels form an integrated display part having a width equal to a width of the shelf board.

17. The large-sized display panel of claim 15, wherein the plurality of display panels includes two types of display panels where a width of the base differs.

18. The large-sized display panel of claim 15, further comprising:
a connecting component which connects the display panels and includes a magnet that fixes the wiring part and the driving part to the shelf board.

19. The large-sized display panel of claim 15, wherein the display panels have bases that are connectable such that the display panels are integrated.

20. The large-sized display panel of claim 15, wherein the bases are configured to be inserted into receiving parts of the shelf board such that the display panels are integrated.
